(19) United States
(12) Patent Application Publication
(10) Pub. No.: US 2025/0219382 A1
(43) Pub. Date: Jul. 3, 2025

(54) LIGHTNING INDUCTION DEVICE

(71) Applicant: Nippon Telegraph and Telephone Corporation, Tokyo (JP)

(72) Inventors: Masato MARUYAMA, Musashino-shi, Tokyo (JP); Toshihisa MASUDA, Musashino-shi, Tokyo (JP); Atsushi NAGAO, Musashino-shi, Tokyo (JP); Takash IKEDA, Musashino-shi, Tokyo (JP)

(21) Appl. No.: 18/875,375

(22) PCT Filed: Jun. 21, 2022
(86) PCT No.: PCT/JP2022/024673

§ 371 Date: Dec. 16, 2024

(51) Int. Cl. H02G 13/00; H01T 19/04

(52) U.S. Cl. CPC H02G 13/40; H01T 19/04; H02G 13/20; H02G 13/80

(57) ABSTRACT

The lightning induction device includes a projection rod, an intermediate conductor, a lowermost conductor, and a switch unit. The projection rod, the N intermediate conductors, and the grounded lowermost conductor are coupled in an upward direction via the N+1 switch units, and all of the switch units are turned on, so that the projection rod and all of the intermediate conductors are instantaneously grounded.

### TECHNICAL FIELD

The present invention relates to a lightning induction device.

### BACKGROUND ART

Nowadays, lightning strikes are becoming more common with more extreme weather conditions, and thus research and development have been actively conducted to provide effective countermeasures to control lightning and protect people and facilities. Non Patent Literatures 1 and 2 describe a lightning conductor in which a small rocket to which a conductive wire is attached is launched toward a thundercloud.

In general, the tip of a highly elevated conductive structure has high electric field strength, and thus is likely to trigger a lightning strike. On the other hand, corona discharge is likely to occur due to electric field concentration at the tip of a highly elevated structure. A thundercloud comes and forms a charge layer as corona charges generated by corona discharge are diffused in the air. This charge layer acts as an electrostatic shield on the highly elevated structure and weakens the electric field strength at the tip. That is, typical concentration of electric field near the tip of the highly elevated structure is not ideal. The corona charge includes a cation generated by separation of electrons from gas molecules accompanying an electron avalanche, and a charged aerosol generated by attachment of aerosol to the cation.

Rocket-induced lightning overcomes the influence of a corona charge layer through the velocity of the rocket. In particular, considering that a corona charge diffusion rate is approximately 100 m/s, a conductive wire is extended at a speed of at least 100 m/s from the ground toward the sky using a rocket. Although a corona discharge occurs at the rocket tip, since the rocket speed is faster than the corona charge diffusion rate, the rocket tip is not affected by corona shielding, and ideal electric field concentration is achieved. This causes the corona discharge at the rocket tip to be converted into an upward leader, triggering a lightning strike.

### CITATION LIST

### Non Patent Literature

Non Patent Literature 1: Kenji Horii, “Kaminari wa seigyo dekiruka?—Rocket Yurai nado—(in Japanese) [Can Lightning Be Controlled?—Rocket-Induced Lightning and Others],” Journal of the Electrical Society, Vol. 110, No. 1, 1990, pp. 21-25

Non Patent Literature 2: Katsuya Ona, “Kaminari Taisaku Kento no Scenario Kento (in Japanese) [Review of Lightning Countermeasure Scenarios]”, Power Reactor and Nuclear Fuel Development Corporation (PNC), January 1993

### SUMMARY OF INVENTION

### Technical Problem

However, rocket launching involves danger due to explosive gunpowder, and there are legal restrictions on storage, transportation, and use. If the rocket-induced lightning fails, the rocket and the wire fall from the sky, and thus, it is necessary to have a sufficient separation distance from the launch site, making it difficult to do it in a city. The rocket is disposable, and the wire is also fused by lightning when a lightning strike is successfully induced. Therefore, consecutive rocker launches in a short time are challenging.

The present invention has been made address such problems, and an object thereof is to find a safer solution for inducing a lightning strike.

### Solution to Problem

One aspect of the present invention is a lightning induction device for inducing a lightning strike, including: a plurality of conductors; and a plurality of switches disposed between the plurality of conductors and configured to switch a conduction state between the conductors, wherein any one of the plurality of conductors is grounded while the plurality of conductors are connected in an upward direction via the plurality of switches, and all of the plurality of conductors are grounded by turning on all of the plurality of switches.

### Advantageous Effects of Invention

According to the present invention, it is possible to find a safer solution for inducing a lightning strike.

### BRIEF DESCRIPTION OF DRAWINGS

FIG. 1 is a diagram illustrating one example of a configuration of a lightning induction device according to the present embodiment.

FIG. 2 is a diagram illustrating one example of a configuration of a switch unit.

FIG. 3 is a diagram illustrating one example of an equipotential surface when a switch is turned off.

FIG. 4 is a diagram illustrating one example of the equipotential surface when the switch is turned on.

### DESCRIPTION OF EMBODIMENTS

Hereinafter, embodiments of the present invention will be described with reference to the drawings.

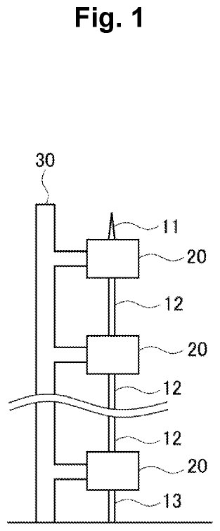

FIG. 1 is a diagram illustrating one example of a configuration of a lightning induction device according to the present embodiment. A lightning induction device illustrated in the drawing is a device in which a projection rod 11, N (N is a natural number) intermediate conductors 12, and the lowermost conductor 13 are connected in an upward direction (vertical direction) via N+1 switch units 20. A lightning strike is induced by turning on the switch units 20 (hereinafter, also referred to as a “switch”) when a thunderstorm comes. N is, for example, 50, but is not limited thereto.

The projection rod 11 is a so-called lightning rod, and is disposed on an upper surface of the uppermost switch unit 20. For example, a metal rod or pipe having a length of 500 mm and a diameter of 20 mm is used as the projection rod 11. It is preferred that the projection rod 11 has a pointed tip.

The intermediate conductor 12 is a conductor that electrically connects upper and lower switch units 20. The intermediate conductor 12 is connected to the projection rod 11 or the intermediate conductor 12 above via the upper switch unit 20, and is connected to the intermediate conductor 12 below or the lowermost conductor 13 via the lower switch unit 20. As the intermediate conductor 12, for example, a copper stranded wire having a length of 2000 mm and a nominal cross-sectional area of 60 mm² is adopted. All the intermediate conductors 12 may not have the same size and be made of same material.

The lowermost conductor 13 is a conductor disposed on a lower surface of the lowermost switch unit 20 and grounded. For example, as the lowermost conductor 13, a copper stranded wire having a length of 1000 mm and a nominal cross-sectional area of 60 mm² is adopted. The length of the lowermost conductor 13 is desirably about half the length of the intermediate conductor 12.

The dimensions and the number of the projection rod 11, the intermediate conductors 12, and the lowermost conductor 13 are not limited to the example above. The intermediate conductor 12 and the lowermost conductor 13 may not be an electric wire like a copper stranded wire, but may be a metal rod.

The switch units 20 are disposed between conductors (projection rod 11, intermediate conductors 12, and lowermost conductor 13) and switches a conduction state between the conductors. When the switch unit 20 is turned on, the conductor connected to the upper side and the conductor connected to the lower side are conducted, and when the switch unit 20 is turned off, the conductor connected to the upper side and the conductor connected to the lower side are insulated. When all the switch units 20 are turned on, the projection rod 11 and all the intermediate conductors 12 are grounded.

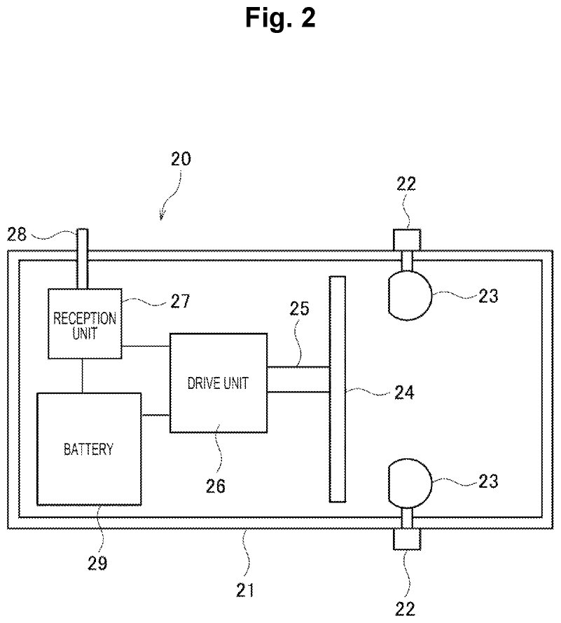

FIG. 2 is a diagram illustrating one example of a configuration of the switch unit 20. The switch unit 20 includes terminals 22 on each of an upper surface and a lower surface of a housing 21 made of an insulator such as fiber reinforced plastics (FRP). The projection rod 11, the intermediate conductor 12, or the lowermost conductor 13 is electrically connected to each of the upper and lower terminals 22.

Each of upper and lower contacts 23 is electrically connected to each of the upper and lower terminals 22 and is disposed apart from each other within the housing 21. The contact 23 is desirably spherical. Accordingly, when the switch is turned off, electric field concentration at a lower end of the projection rod 11, upper and lower ends of the intermediate conductor 12, and an upper end of the lowermost conductor 13 is inhibited, thereby suppressing corona discharge.

A contactor 24 is a conductor that conducts or insulates between the two contacts 23. By bringing the contactor 24 into contact with each of the two contacts 23, the two contacts 23 are conducted. In the example illustrated FIG. 2, a contact portion of the contact 23 in contact with the contactor 24 is a flat surface in accordance with the shape of the contactor 24. When the contactor 24 comes into contact with the two contacts 23, the switch is turned on (upper and lower conductors are conducted), and when the contactor 24 disengages from the contact 23, the switch is turned off (upper and lower conductors are insulated).

A drive unit 26 moves the contactor 24 via an insulator 25 to turn the switch on and off. Specifically, the drive unit 26 moves the insulator 25 to the right side in the drawing to bring the contactor 24 into contact with the two contacts 23 to turn on the switch, and moves the insulator 25 to the left side in the drawing to move the contactor 24 away from the contacts 23 to turn off the switch.

A reception unit 27 receives a radio signal through an antenna 28, and drives the drive unit 26 according to the received radio signal. Specifically, when the reception unit 27 receives a turn-on command, the drive unit 26 is driven such that the contactor 24 comes into contact with the contacts 23. When the reception unit 27 receives a turn-off command, the drive unit 26 is driven such that the contactor 24 moves away from the contacts 23.

A battery 29 supplies power to the drive unit 26 and the reception unit 27. Since the switch unit 20 includes the battery 29, it is not necessary to wire a power supply line from the ground. When the power supply line is wired to each switch unit 20 from the ground, a corona discharge is generated from the uppermost portion of the power supply line, which may reduce the effect of the lightning induction device. The battery 29 may be replaced periodically or may be charged using a wireless power supply mechanism.

A support tower 30 is an insulator that supports the switch units 20. The support tower 30 is constructed of FRP or wood. As illustrated in FIG. 1, the support tower 30 supports the switch units 20, but may support main components other than the switch units 20. Instead of the support tower 30, the projection rod 11 or the uppermost switch unit 20 may be lifted by, for example, a lightning resistant drone.

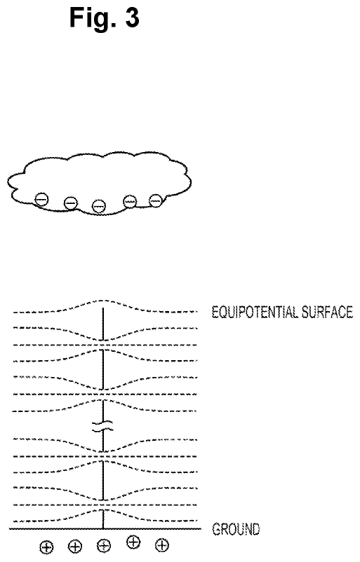

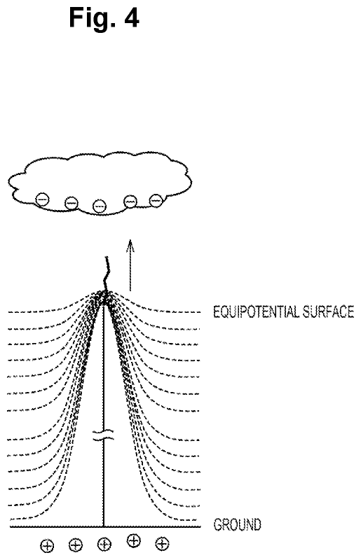

Next, a lightning induction method by the lightning induction device of the present embodiment will be described with reference to FIGS. 3 and 4.

The switches of the lightning induction device are typically turned off. When the switches of the lightning induction device are turned off, the conductors are insulated from each other, and the electric field near the upper end of the lightning induction device does not become strong as illustrated in FIG. 3. A solid line extending in the vertical direction from the ground in FIGS. 3 and 4 is a conductor of the lightning induction device. A break in the solid line indicates that the switches are turned off. Horizontal dashed lines represent the equipotential surfaces.

All switches of the lightning induction device are turned on at a timing at which it is desired to trigger a lightning strike. For example, an operator transmits a turn-on command to all the switches at a timing when it is desired to induce a lightning strike. When all the switches are turned on, all the conductors are instantaneously grounded, and as shown in FIG. 4, the equipotential surfaces protrude upward, and the interval between the equipotential surfaces near the upper end of the lightning induction device becomes very narrow. That is, the electric field strength near the upper end of the lightning induction device becomes very intensive. Accordingly, dielectric breakdown is initiated at the upper end of the lightning induction device before the corona charge diffuses, and a plasma electric path called a leader extends toward the cloud. When the leader reaches the electric charge in the cloud, the electric charge in the cloud is neutralized through the plasma electric path, and a large current flows through the lightning induction device (lightning strike).

Even if the lightning induction fails once, the lightning induction device can immediately attempt to trigger a lightning strike again by turning off and on the switches. As long as the conductors and the switches are rigid enough not to be destroyed by a lightning strike, the lightning induction device can induce lightning many consecutive times.

As described above, the lightning induction device of the present embodiment is characterized that the projection rod 11, the intermediate conductors 12, and the grounded lowermost conductor 13 are coupled in an upward direction via the switch units 20, and all of the switch units 20 are turned on, so that the projection rod 11 and all of the intermediate conductors 12 are instantaneously grounded. Accordingly, ideal electric field concentration can be achieved at the upper end of the lightning induction device, and a lightning strike can be induced at an intentional timing of turning on the switch. By intentionally triggering a lightning strike and neutralizing cloud charges, surrounding people, buildings and facilities can be protected from being struck by lightning.

Since the lightning induction device of the present embodiment does not launch a rocket, it can induce a lightning strike more safely and can be installed in town. Moreover, since the gunpowder is unnecessary, legal/regulatory measures are unnecessary.

### REFERENCE SIGNS LIST

11 Projection rod
12 Intermediate conductor
13 Lowermost conductor
20 Switch unit
21 Housing
22 Terminal
23 Contact
24 Contactor
25 Insulator
26 Drive unit
27 Reception unit
28 Antenna
29 Battery
30 Support tower

1. A lightning induction device for inducing a lightning strike, comprising:
a plurality of conductors; and
a plurality of switches disposed between the plurality of conductors and configured to switch a conduction state between the conductors,
wherein any one of the plurality of conductors is grounded while the plurality of conductors are connected in an upward direction via the plurality of switches, and
all of the plurality of conductors are grounded by turning on all of the plurality of switches.

2. The lightning induction device according to claim 1, wherein each switch of the plurality of switches includes:
two terminals electrically connected to upper and lower conductors;
two contacts electrically connected to each of the two terminals and disposed apart from each other; and
a contactor configured to contact the two contacts to conduct the two contacts, and turn on the switch.

3. The lightning induction device according to claim 2, wherein each switch of the plurality of switches includes:
a reception unit configured to receive a radio signal for switching on and off of the switch;
a drive unit configured to move the contactor according to the radio signal; and
a battery configured to supply power to the reception unit and the drive unit.

4. The lightning induction device according to claim 1, wherein a distal end of an uppermost conductor of the plurality of conductors disposed at an uppermost portion is pointed, and
a length of a conductor to be grounded is half a length of any other conductor of the plurality of conductors.
